(19) United States
(12) Patent Application Publication
(10) Pub. No.: US 2015/0146109 A1
(43) Pub. Date: May 28, 2015

(54) DISPLAY DEVICE AND TELEVISION DEVICE

(71) Applicant: Sharp Kabushiki Kaisha, Osaka-shi, Osaka (JP)

(72) Inventor: Nobuhiro Kasai, Osaka-shi (JP)

(21) Appl. No.: 14/401,875

(22) PCT Filed: Jun. 12, 2013
(86) PCT No.: PCT/JP2013/066181

§ 371 Date: Nov. 18, 2014

(30) Foreign Application Priority Data
Jun. 19, 2012 (JP) 2012-137790

(51) Int. Cl. G02F 1/1333; G02F 1/1335; F21V 8/00

(52) U.S. Cl. CPC G02F 1/133308; G02B 6/0088; G02B 6/0085; G02B 6/0091; G02F 1/1336; G02F 2001/13332; G02F 2001/133314
USPC 348/790; 349/58

(57) ABSTRACT

A liquid crystal display device 10 includes an LED 17, a liquid crystal panel 11, a light guide plate 16 including at least one side-surface as a light entrance surface 16b, a chassis 14 having a bottom plate 14a, a frame 13, an LED board 18, a heat dissipation member 19 having heat dissipation properties, and a fixing screw 40. The frame 13 and the chassis 14 sandwich the liquid crystal panel 11, the LED 17, and the light guide plate 16 therebetween. The heat dissipation member 19 includes a bottom portion 19b arranged on the bottom plate 14a and a stand-up portion 19a projecting from the bottom portion 19b toward the liquid crystal panel 11. The LED board 18 is mounted on a surface of the stand-up portion 19a. The fixing screw 40 is passed through the stand-up portion 19a and the LED board 18 and a tip portion thereof is fixed in the light entrance surface 16b so that the fixing screw fixes the stand-up portion and the LED board 18 to the light guide plate 16.

### TECHNICAL FIELD

The present invention relates to a display device and a television device.

### BACKGROUND ART

Displays in image display devices, such as television devices, are now being shifted from conventional cathode-ray tube displays to thin displays, such as liquid crystal displays and plasma displays. With the thin displays, the thicknesses of the image display devices can be reduced. Liquid crystal panels included in liquid crystal display devices do not emit light, and thus backlight devices are required as separate lighting devices. An edge light-type backlight device including a light guide plate with a light entrance surface on the side and light sources such as LEDs arranged closer to the side of the light guide plate is known as an example of such backlight devices.

With recent increase in size of a liquid crystal display device, a demand for reduction in thickness of the liquid crystal display device or in size of a frame thereof has been raised. Patent document 1 discloses an edge-light type backlight device that can reduce the thickness and the frame-size.

In recent years, a demand for reduction in production cost or a demand for further reduction in thickness has been raised. Therefore, a configuration without a cabinet, which is made of a synthetic resin and serves as an exterior member of a liquid crystal display unit, has been considered. A liquid crystal display device without such a cabinet can reduce the thickness or the frame-size by the size of the cabinet.

### RELATED ART DOCUMENT

### Patent Document

Patent Document 1: Japanese Unexamined Patent Application Publication No. 2007-80564

### Problem to be Solved by the Invention

In a liquid crystal display device including an edge-light type backlight device, components such as a light source board and a heat dissipation member may be arranged close to a light guide plate within a casing. The light source board may include light sources mounted thereon. The heat dissipation member may be located in between the light source board and the casing. The components may have different dimensional accuracy, which may be affected by production unevenness, or different thermal expansion coefficients. If thermal expansion or contraction occurs in the components because of heat generated from the light sources, the components expand or contract in different levels and this may change a distance between the light sources and a light entrance surface.

In the backlight device described in Patent document 1, the light guide plate is sandwiched between two light source boards. If thermal expansion or contraction occurs in the light guide plate or the light source boards, a distance between light sources and a light entrance surface may largely change. The distance change between the light sources and the light entrance surface may decrease light-entering efficiency of light exiting the light sources and entering the light guide plate. Therefore, preferable optical properties cannot be maintained.

### Disclosure of the Present Invention

A technology disclosed herein was made in view of the above circumstances. An object of the technology described herein is to provide a cabinet-less display device in which high light-entering efficiency is maintained even if expansion occurs in a light guide plate.

### Means for Solving the Problem

A technology disclosed herein relates to a lighting display including a light source, a display panel, a light guide plate, a chassis, a frame, a light source board, a heat dissipation member, and a fixing screw. The display panel is configured to provide a display using light from the light source. The light guide plate is arranged on an opposite side from a display surface side of the display panel so as to overlap the display panel and configured to guide the light from the light source toward the display panel. The light guide plate includes at least one side surface configured as a light entrance surface. The light entrance surface faces the light source. The chassis includes at least a bottom plate and arranged on an opposite side of the light guide plate from the display panel. The frame is arranged on the display surface side of the display panel and holds the display panel, the light source, and the light guide plate between the frame and the chassis. The light source board includes the light source mounted on a surface thereof and arranged such that the surface thereof is parallel to the light entrance surface. The heat dissipation member having a heat dissipation property includes a bottom portion and a stand-up portion. The bottom portion is arranged on the bottom plate along the bottom plate. The stand-up portion projects from the bottom portion toward a display panel side. The light source board is attached on a surface of the stand-up portion. The fixing screw is passed through the stand-up portion and the light source board and includes a tip portion that is fixed in the light entrance surface. The fixing screw fixes the stand-up portion and the light source board to the light guide plate.

According to the display device, the stand-up portion and the light source board are fixed to the light guide plate. Thus the distance between the light source and the light entrance surface is fixed. Even when components, such as the light guide plate and the heat dissipation member, thermally expand, the distance between the light source and the light entrance surface is maintained. Therefore, the distance between the light source and the light entrance surface before the thermal expansion and the distance therebetween after the thermal expansion remain constant. With this configuration, even if the component such as the heat dissipation member expands, light-entering efficiency of rays of light exiting the light source and entering through the light entrance surface does not decrease or is less likely to decrease. Namely, proper optical properties can be maintained.

The bottom portion may be arranged on the bottom plate so as to be slidable in a direction perpendicular to the light entrance surface.

In this configuration, if the component such as the heat dissipation member expands in the direction perpendicular to the light entrance surface, the heat dissipation member slides in the direction perpendicular to the light entrance surface by a length corresponding to the expanded amount. With this configuration, a stress exerted on the heat dissipation member is released and thus warping due to the stress does not occur or is less likely to occur in each component. Therefore, the distance between the light source and the light entrance surface is less likely to change.

The bottom portion may include a bottom-portion through hole through which an attachment member for attaching the bottom portion to the chassis is to be passed. The bottom-portion through hole may have an oval shape with a major axis along the direction perpendicular to the light entrance surface.

In this configuration, the heat dissipation member is movable in a direction along the major axis of the bottom-portion through hole. This provides a specific configuration in which the heat dissipation member can slide in the direction perpendicular to the light entrance surface.

The light source board may have a rectangular shape. The light source may include a plurality of light sources arranged along a longitudinal direction of the light source board. The fixing screw includes a plurality of fixing screws. Each of the fixing screws may be passed through a portion of the light source board between the light sources.

In this configuration, the light source board and the heat dissipation member are fixed to the light guide plate with multiple fixing screws. Even if the light source board warps along the longitudinal direction, the distance between the light sources and the light entrance surface does not change or is less likely to change due to the warping. Therefore, the distance between the light sources and the light entrance surface is effectively maintained.

Each of the fixing screws may be passed through the light source board at a midpoint between the adjacent light sources.

In this configuration, each fixing screw is passed through a portion equally apart from the adjacent light sources. Therefore, the light source board is fixed with the fixing screw while a force is evenly applied to each portion thereof between the adjacent light sources without biasing toward one of the adjacent light sources. Thus, the distance between the light source and the light entrance surface is maintained constant with appropriate accuracy.

The light source may have a light distribution following the Lambertian distribution. The tip portion of the fixing screw is located inward from the light entrance surface and in an area not overlapping a light distribution area in which light exiting the light source and entering through the light entrance surface is distributed.

In this configuration, the light that exits the light source and enters through the light entrance surface is not blocked by the fixing screw. Therefore, uneven brightness does not occur or is less likely to occur at the light exit surface of the light guide plate due to blocking of light by the fixing screws.

The fixing screw may be made of material having transparency and may be passed through the light source board at a point between a midpoint of the adjacent light sources and one of the adjacent light sources.

In this configuration, the fixing screw is arranged close to one of the adjacent light sources. Even if rays of light are directed to the fixing screw, the fixing screw does not block the rays of light because the fixing screw has transparency. Therefore, the light source board can be fixed by the fixing screw at a point close to the light source. Namely, the distance between the light source and the light entrance surface can be fixed with appropriate accuracy.

The light source board may have a rectangular shape and each of the fixing screws may passed through an end portion of a long dimension of the light source board.

With this configuration, the number of the fixing screws is reduced and thus the production process is simplified and components cost is reduced.

The light source may be arranged in a substantially middle of a short dimension of the light source board, and the fixing screw may be passed through the light source board at a point between the middle of the short dimension of the light source board and an end of the light source board close to the bottom plate.

With this configuration, light emitted from the light sources that are arranged at the end portions of the light source board in the longitudinal direction is less likely to be blocked by the fixing screws arranged at the end portions of the light source board. Therefore, uneven brightness does not occur or is less likely to occur at the light exit surface of the light guide plate due to blocking of light by the fixing screws.

In the technology disclosed herein, a display device including a liquid crystal panel using liquid crystals as the display panel has novelty and utility. Further, a television device including the above display device has novelty and utility.

### Advantageous Effect of the Invention

According to the technology disclosed herein, in the display device without a cabinet, high light-incidence efficiency is maintained even if expansion of a light guide plate occurs.

### BRIEF DESCRIPTION OF THE DRAWINGS

FIG. 1 is an exploded perspective view of a general configuration of a television device TV and a liquid crystal display unit LDU according to a first embodiment.

FIG. 2 is a rear view of the television device TV and a liquid crystal display device 10.

FIG. 3 is an exploded perspective view of a general configuration of the liquid crystal display unit LDU of the liquid crystal display device 10.

FIG. 4 is a cross-sectional view of the liquid crystal display device 10 taken along a short-side direction thereof.

FIG. 5 is a cross-sectional view of the liquid crystal display device 10 taken along a long-side direction thereof.

FIG. 6 is a magnified cross-sectional view of a major part of the light crystal display device 10, illustrating a fixing screw 40 and its vicinity in FIG. 5.

FIG. 7 is a plan view of an LED unit LU and an end portion of a light guide plate 16 closer to a light entrance surface 16b viewed from a front side.

FIG. 8 is a magnified perspective view of a heat dissipation member 19, illustrating an end portion of the heat dissipation member 19 in a long-side direction thereof.

FIG. 9 is a plan view of an LED unit LU and an end portion of a light guide plate 116 closer to a light entrance surface 116b viewed from a front side according to a second embodiment.

FIG. 10 is an exploded perspective view of a general configuration of a liquid crystal display device 210 and a liquid crystal display unit LDU according to a third embodiment.

FIG. 11 is a magnified perspective view of a long-side end portion of each of an LED unit LU and a light entrance surface 216b of a light guide plate 216.

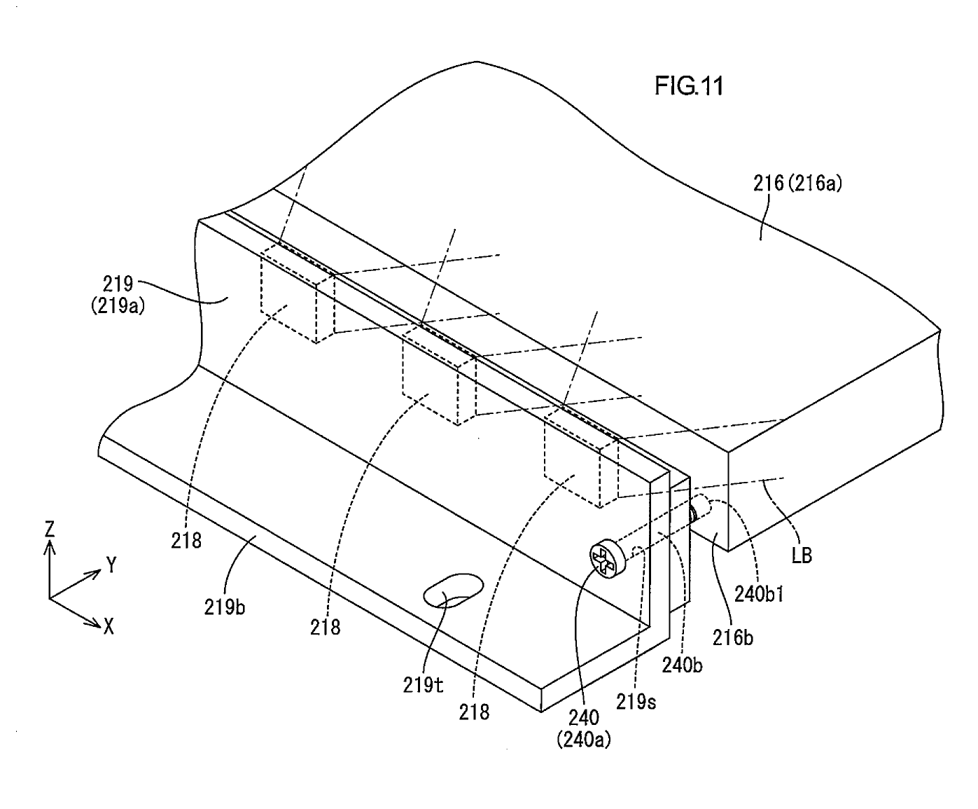

### MODE FOR CARRYING OUT THE INVENTION

### First Embodiment

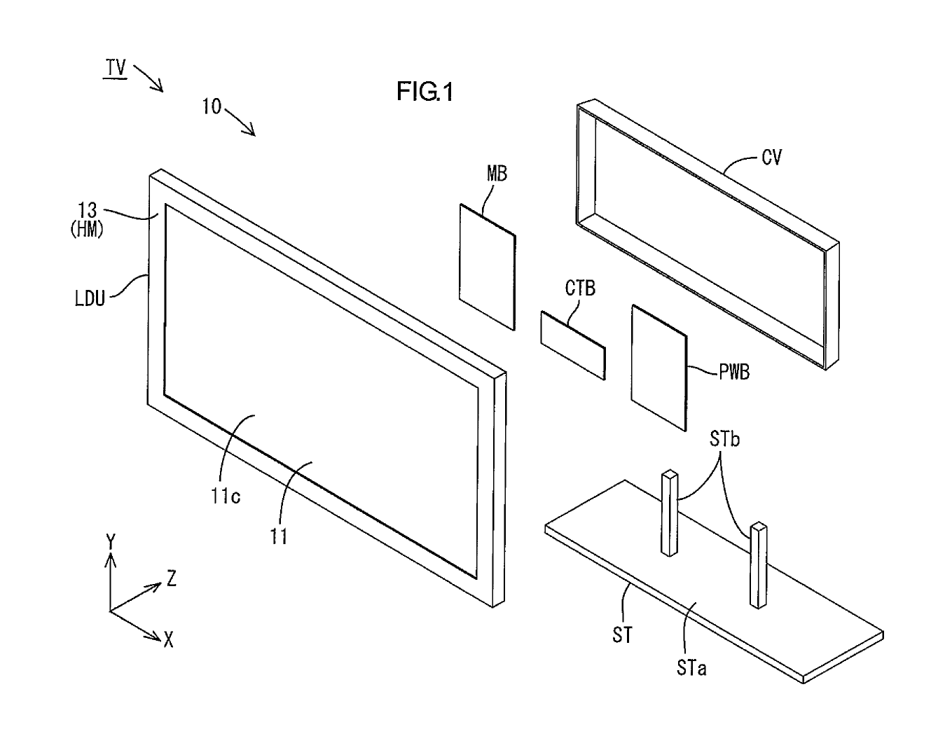

A first embodiment will be described with reference to FIGS. 1 to 10. A liquid crystal display device 10 according to this embodiment will be described. X-axis, Y-axis and Z-axis are indicated in some drawings. The axes in each drawing correspond to the respective axes in other drawings. The Y-axis direction corresponds to a vertical direction and the X-axis direction corresponds to a horizontal direction. An upper side and a lower side are based on the vertical direction unless otherwise specified.

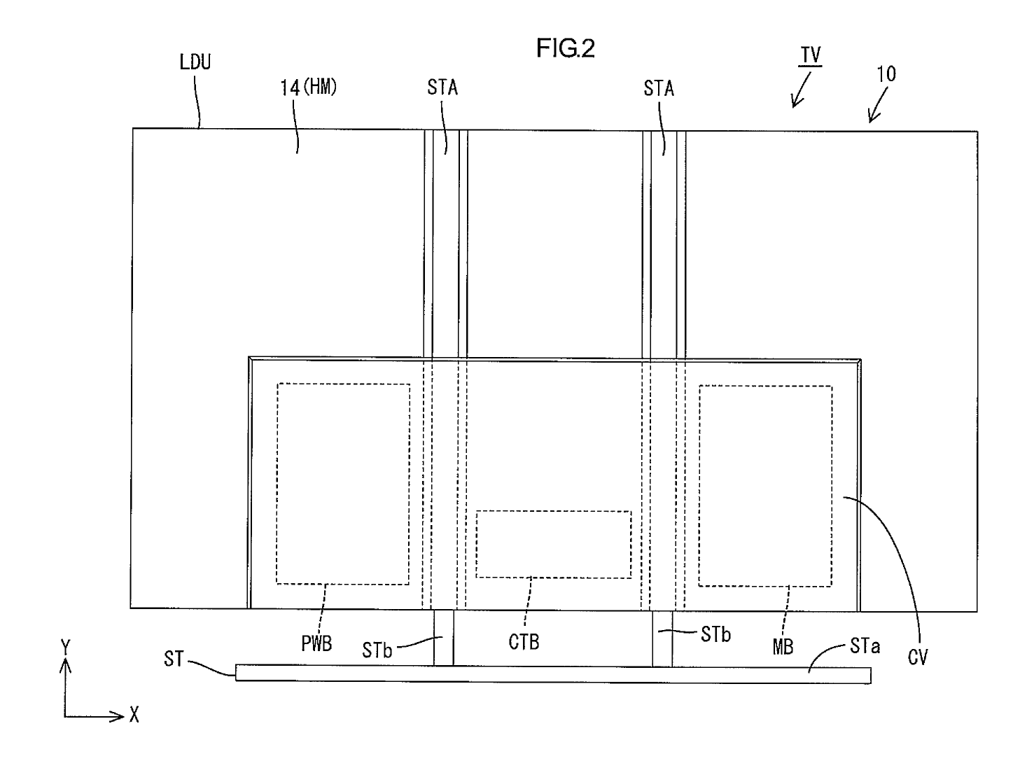

A television device TV includes a liquid crystal display unit LDU, boards PWB, MB, and CTB, a cover CV, and a stand ST. The boards PWB, MB, and CTB are attached to a rear surface (aback surface) of the liquid crystal display unit LDU. The cover CV is attached to the rear surface of the liquid crystal display unit LDU so as to cover the boards PWB, MB, and CTB. The stand ST holds the liquid crystal display unit LDU such that a display surface of the liquid crystal display unit LDU extends in the vertical direction (the Y-axis direction). The liquid crystal display device 10 according to this embodiment has the same configuration as the above-described television device TV except for at least a component for receiving television signals (e.g. a tuner included in a main board MB). As illustrated in FIG. 2, the liquid crystal display unit LDU has a landscape rectangular overall shape (rectangular and longitudinal). The liquid crystal display unit LDU includes a liquid crystal panel 16 as a display panel and a backlight device 12 as a light source. The liquid crystal panel 11 and the backlight device 12 are collectively held by a frame 14 and a chassis 14. The frame 13 and the chassis 14 are external members that provide an external configuration of the liquid crystal display device 10. The chassis 14 in this embodiment is one of the components to form the exterior and a part of the backlight device 12.

Configurations of the liquid crystal display device 10 on a rear surface side will be described. As illustrated in FIG. 2, stand fitting members STA are attached to a rear surface of the chassis 14 that provides an external configuration of the back of the liquid crystal display device 10. The stand fitting members STA are spaced away from each other in an X-axis direction and extend along the Y-axis direction. Each stand fitting member STA has a cross section that corresponds to a cross section of a channel beam and opens to the chassis 14. A space is provided between the stand fitting member STA and the chassis 14. Support portions STb included in the stand ST are inserted in the respective stand fitting members STA. The space provided in the stand fitting member STA is configured to be a path through which wiring members (e.g. electric wires) which are connected to an LED board 18 are passed. The LED board 18 is included in the backlight device 12. The stand ST includes a base STa and the support portions STb. The base STa extends parallel to the X-Z plane. The support portions STb stand on the base STa in the Y-axis direction. The cover CV is made of synthetic resin and attached to a part of the rear surface of the chassis 14. Specifically, as illustrated in FIG. 2, the cover CV covers a lower half part of the chassis 14 so as to cross over the stand fitting members STA in the X-axis direction. A component storage space is provided between the cover CV and the chassis 14 such that the boards PWB, MB, and CTB, which will be described next, are arranged therein.

As illustrated in FIG. 2, the liquid crystal display device 10 includes a power source board PWB, a main board MB, and a control board CTB as the boards PWB, MB, and CTB. The power source board PWB will be referred to as a power supply of the liquid crystal display device 10 and supplies drive power to the other boards MB and CTB and LEDs (an example of light sources) 17 included in the backlight device 12. Namely, the power source board PWB also serves as “an LED drive board that drives the LEDs 17”. The main board MB includes at least a tuner and an image processor, which are not illustrated. The tuner is configured to receive television signals. The image processor performs image processing on the received television signals. The main board MB is configured to output the processed image signals to the control board CTB, which will be described next. If an external image reproducing device, which is not illustrated, is connected to the liquid crystal display device 10, image signals from the image reproducing device are input to the main board MB. The image processor included in the main board MB processes the image signals, and the main board MB outputs the processed image signals to the control board CTB. The control board CTB is configured to convert the image signals, which is sent from the main board, to driving signals for liquid crystals and to supply the driving signals to the liquid crystal panel 11.

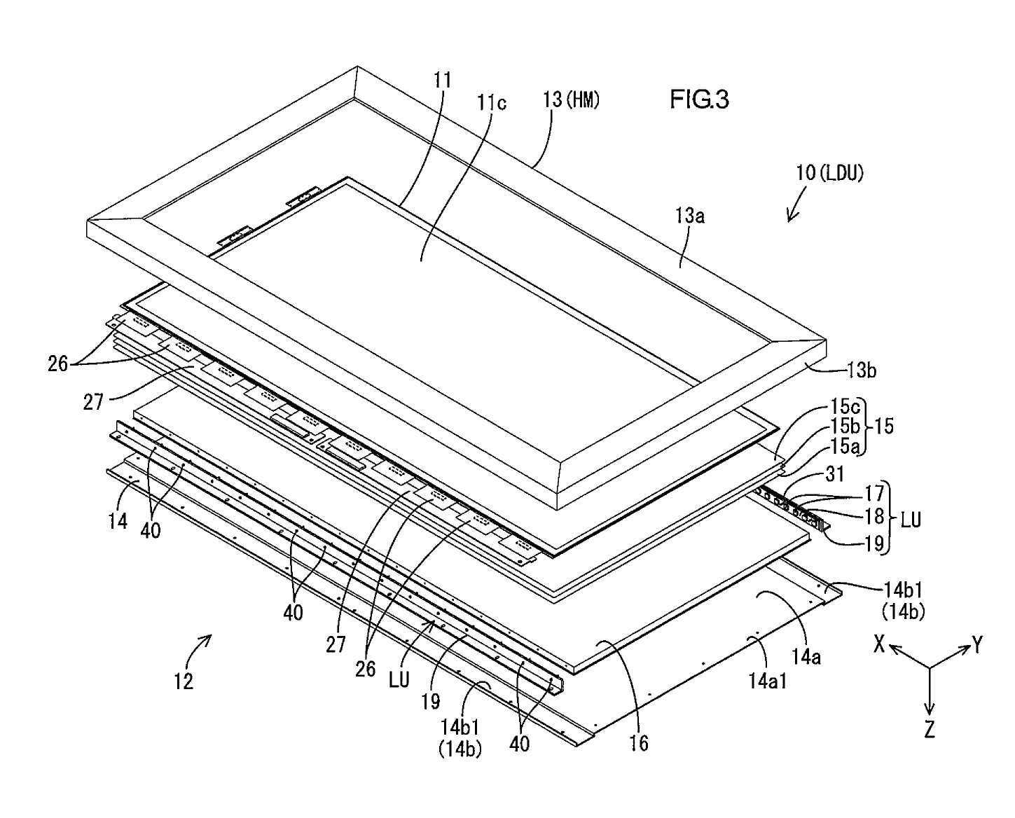

As illustrated in FIG. 3, components of the liquid crystal display unit LDU included in the liquid crystal display device 10 are arranged in a space provided between the frame 13 that provides a front external configuration and the chassis 14 that provides a rear external configuration. The components arranged between the frame 13 and the chassis 14 are at least the liquid crystal panel 11, an optical member 15, alight guide plate 16, and LED units 20. The liquid crystal panel 11, the optical member 15, and the light guide plate 16 are placed on top of one another and held between the frame 13 on the front side and the chassis 14 on the rear side. The backlight device 12 includes the optical member 15, the light guide plate 16, the LED units LU, and the chassis 14. Namely, the liquid crystal display unit LDU without the liquid crystal panel 11 and the frame 13 is the backlight device 12. The LED units LU included in the backlight device 12 are arranged in the space between the frame 13 and the chassis 14. Two LED units LU are each arranged on each end of a short dimension of the light guide plate 16 (in the Y-axis direction). Each LED unit LU includes LEDs 17 as light sources, the LED board 18, and a heat dissipation member (a heat spreader) 19. The LEDs 17 are mounted on the LED board 18. The LED board 18 is attached to the heat dissipation member 19. Each component will be described next.

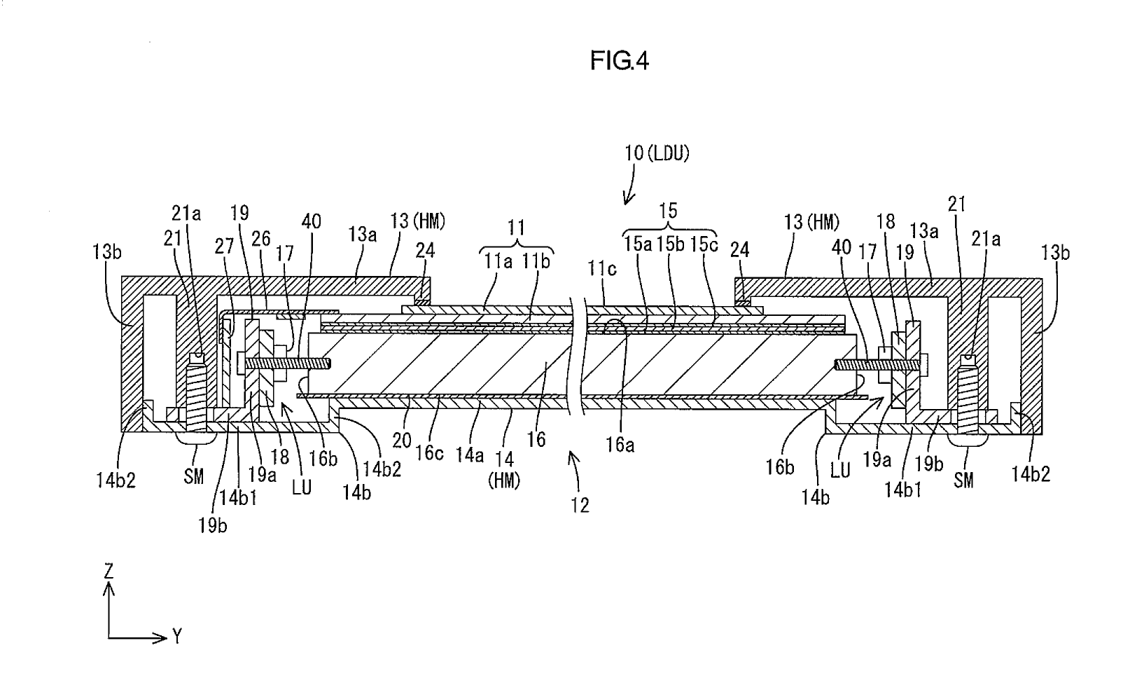

As illustrated in FIG. 3, the liquid crystal panel has a landscape rectangular shape (rectangular and longitudinal) in a plan view and includes a pair of glass substrates 11a and 11b (see FIG. 4) and liquid crystals. The substrates 11a and 11b having high light transmissivity are bonded together with a predetermined gap therebetween. The liquid crystals are sealed between the substrates 11a and 11b. On one of the substrates (an array substrate 11b), switching elements (e.g. TFTs), pixel electrodes, and an alignment film are arranged. The switching elements are connected to gate lines and source lines that are arranged perpendicular to each other. The pixel electrodes are connected to the switching elements. On the other one of the substrates (a CF substrate 11a), color filters, a counter electrode, and an alignment film are arranged. The color filters include red (R), green (G), and blue (B) color portions that are arranged in a predetermined arrangement. The liquid crystal panel 11 is placed on a front side of the optical member 15, which will be described later. A rear-side surface of the liquid crystal panel 11 (an outer-side surface of a polarizing plate on the rear side) is fitted to the optical member 15 with minimal gaps therebetween. Therefore, dust is less likely to enter between the liquid crystal panel 11 and the optical member 15. The liquid crustal panel 11 includes a display surface 11c. The display surface 11c includes a display area and a non-display area. The display area is an inner area of a screen in which images are displayed. The non-display area is an outer area of the screen around the display area with a frame-like shape. The liquid crystal panel 11 is connected to the control board CTB via a driver for driving the liquid crystals and flexible boards 26. The liquid crustal panel 11 displays an image in the display area of the display surface 11c based on signals sent from the control board CTB. The polarizing plates, which are not illustrated, are arranged on outer sides of the substrates 11a and 11b.

As illustrated in FIG. 3, similar to the liquid crystal panel 11, the optical member 15 has a landscape rectangular shape in a plan view and has the same size (i.e., a short-side dimension and a long-side dimension) as the liquid crystal panel 11. The optical member 15 is placed on the front side of the light guide plate 16 (a light exit side), which will be described later, and sandwiched between the light guide plate 16 and the liquid crystal panel 11. The optical member 15 includes three sheets that are placed on top of one another. Specifically, a diffuser sheet 15a, a lens sheet (a prism sheet) 15b, and a reflecting type polarizing sheet 15c are placed on top of one another in this sequence from the rear side (the light guide plate 16 side). Each of the three sheets 15a, 15b, and 15c has the substantially same size in a plan view.

The light guide plate 16 is made of substantially transparent (high transmissivity) synthetic resin (e.g. acrylic resin or polycarbonate such as PMMA) which has a refractive index sufficiently higher than that of the air. As illustrated in FIG. 3, the light guide plate 16 has a landscape rectangular shape in a plan view similar to the liquid crystal panel 11 and the optical member 15. A thickness of the light guide plate 16 is larger than a thickness of the optical member 15. A long-side direction and a short-side direction of a main surface of the light guide plate 16 correspond to the X-axis direction and the Y-axis direction, respectively. A thickness direction of the light guide plate 16 that is perpendicular to the main surface of the light guide plate 16 corresponds to the Z-axis direction. The light guide plate 16 is arranged on the rear side of the optical member 15 and sandwiched between the optical member 15 and the chassis 14. As illustrated in FIG. 4, at least a short-side dimension of the light guide plate 16 is larger than those of the liquid crystal panel 11 and the optical member 15. The light guide plate 16 is arranged such that ends of the short dimension thereof (i.e., ends along a long-side direction of the light guide plate 16) protrude over ends of the liquid crystal panel 11 and the optical member 15 (so as not to overlap in a plan view). The LED units LU are arranged on sides of the short dimension of the light guide plate 16 so as to have the light guide plate 16 between the LED units LU in the Y-axis direction. Light from the LEDs 17 enters the light guide plate 16 through the ends of the short dimension of the light guide plate 16. The light guide plate 16 is configured to guide the light, which is from the LEDs 17 and enters the light guide plate 16 through the ends of the short dimension, toward the optical member 15 (on the front side).

One of the main surfaces of the light guide plate 16 facing the front side (a surface opposite the optical member 15) is a light exit surface 16a. Light exits the light guide plate 16 through the light exit surface 16a toward the optical member 15 and the liquid crystal panel 11. The light guide plate 16 includes outer peripheral end surfaces that are adjacent to the main surfaces of the light guide plate 16, and long-side end surfaces (end surfaces of the short dimension) which have elongated shapes along the X-axis direction are opposite the LEDs 17 (the LED boards 18). A predetermined space is provided between each long-side end and the LEDs 17 (the LED boards 18). The long-side end surfaces are light entrance surfaces 16b through each of which light from LEDs 17 enters. The light entrance surface 16b includes multiple screw holes 16s. The screw holes 16s are arranged at equal intervals along a longitudinal direction of the light entrance surface 16b (the X-axis direction). Each screw hole 16s extends in a direction perpendicular to the light entrance surface 16b and opens to the outside of the light guide plate 16 with a round opening. A tip portion 40b1 of the fixing screw 40, which will be described later, is fitted in the screw hole 16s. As illustrated in FIG. 4, a reflection sheet 20 is arranged on the rear side of the light guide plate 16, i.e., on an opposed surface 16c that is opposite from the light exit surface 16a (a surface opposite the chassis 14). The reflection sheet 20 is arranged to cover an entire area of the opposed surface 16c.

The reflection sheet 20 is arranged so as to be sandwiched between the chassis 14 and the light guide plate 16. Light that exits the light guide plate 16 through the plate surface 16c toward the rear side is reflected by the reflection sheet 20 toward the front side. The reflection sheet 20 is made of synthetic resin and has a white surface having high light reflectivity. A short-side dimension of the reflection sheet 20 is larger than that of the light guide plate 16. The reflection sheet 20 is arranged such that ends of the short dimension thereof protrude closer to the LEDs 17 compared to the light entrance surfaces 16b of the light guide plate 16. Light that travels at an angle from the LEDs 17 toward the chassis 14 is effectively reflected toward the light entrance surfaces 16b of the light guide plate 16 by the protruded portions of the reflection sheet 20.

Next, configurations of the frame 13 and the chassis 14 that constitute the exteriors and a holding member HM will be described. The frame 13 and the chassis 14 are made of metal such as aluminum. Therefore, the mechanical strength (rigidity) and thermal conductivity of the frame 13 and the chassis 14 are higher than those of a frame and a chassis made of synthetic resin. As illustrated in FIG. 3, the frame 13 and the chassis 14 hold the LED units LU at ends of the short dimension of the frame 13 and the chassis 14 (at the respective long sides). The frame 13 and the chassis 14 hold the liquid crystal panel 11, the optical member 15, and the light guide plate 16, which are placed on top of the other, from the front side and the rear side.

As illustrated in FIG. 3, the frame 13 has a landscape rectangular shape so as to surround the display area in the display surface 11c of the liquid crystal panel 11. The frame 13 includes a panel holding portion 13a and a sidewall 13b. The panel holding portion 13a is parallel to the display surface 11c of the liquid crystal panel 11 and presses the liquid crystal panel 11 from the front side. The sidewall 13b protrudes from an outer peripheral portion of the panel holding portion 13a toward the rear side. The panel holding portion 13a and the sidewall 13b form an L-like shape in a cross section. The panel holding portion 13a forms a landscape-rectangular and frame-like shape that corresponds to an outer portion of the liquid crystal panel 11 (i.e., the non-display area, a frame-like portion). The panel holding portion 13a presses a substantially entire area of the outer portion of the liquid crystal panel 11 from the front side. The panel holding portion 13a has a width that is large enough to cover not only the outer portion of the liquid crystal panel 11 but also an outer portion of the optical member 15, an outer portion of the light guide plate 16, and LED units LU from the front side. The outer portions of the optical member 15 and the light guide plate 16 and the LED units LU are located on the outer side with respect to the outer portion of the liquid crystal panel 11 in a radiation direction. Similar to the display surface 11c of the liquid crystal panel 11, a front exterior surface of the panel holding portion 13a (an opposed surface from the surface facing the liquid crystal panel 11) is seen from the front side of the liquid crystal display device 10. The panel holding portion 13a constitutes a front exterior of the liquid crystal display device 10 together with the display surface 11c of the liquid crystal panel 11. The sidewall 13b has a substantially rectangular hollow shape and protrudes from the outer peripheral portion (specifically, an outer peripheral end portion) of the panel holding portion 13a toward the rear side. The sidewall 13b entirely surrounds the liquid crystal panel 11, the optical member 15, the light guide plate 16, and the LED units LU, which are arranged in the space between the frame 13 and the chassis 14. The sidewall 13b surrounds an entire periphery of the rear chassis 14 on the rear side. An outer surface of the sidewall 13b that extends along an outer peripheral surface of the liquid crystal display device 10 can be seen from the outside of the liquid crystal display device 10. Therefore, the outer surface of the sidewall 13b constitutes a top surface, a bottom surface, and side surfaces of the liquid crystal display device 10.

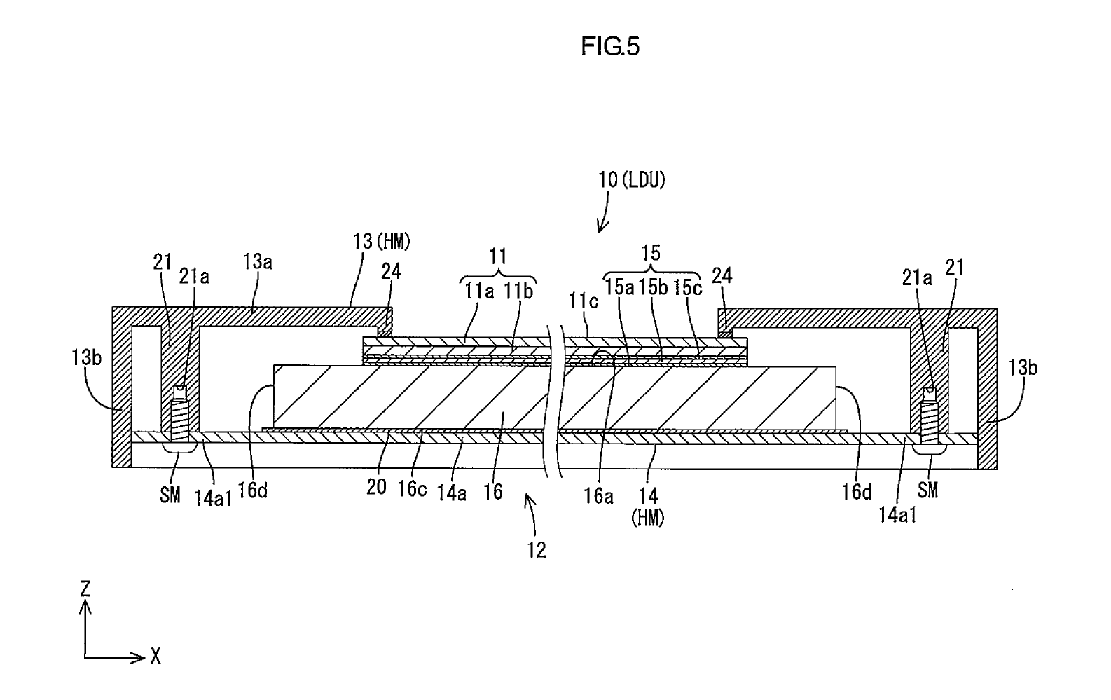

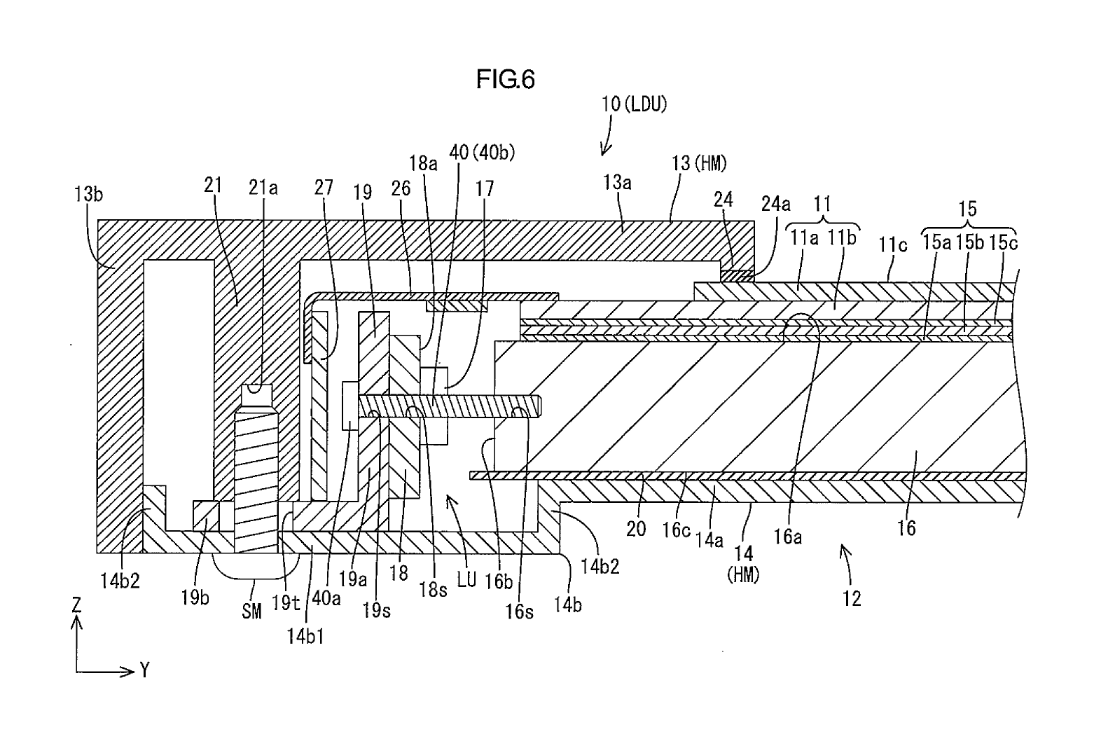

As illustrated in FIGS. 4 and 5, the panel holding portion 13a includes a holding protrusion 24 as a part thereof. The holding protrusion 24 protrudes from an inner edge of the panel holding portion 13a toward the rear-surface side, that is, toward the liquid crystal panel 11. The holding protrusion 24 includes a shock absorber 24a (see FIG. 6) at its protruded end. The holding protrusion 24 presses the liquid crystal panel 11 from the front side via the shock absorber 24a in between. As illustrated in FIGS. 4 and 5, the panel holding portion 13a includes screw attachment portions 21 as a part thereof. Each of the screw attachment portions 21 is located closer to an interior side than the sidewall 13b of the panel holding portion 13a (a position close to the light guide plate 16). Screw members SM (an example of an attachment member) are attached to the screw attachment portion 21. The screw attachment portion 21 protrudes from an inner surface of the panel holding portion 13a in the Z-axis direction toward the rear side and has an elongated block-like shape that extends along each side of the panel holding portion 13a (in the X-axis direction or the Y-axis direction). As illustrated in FIGS. 4 and 5, the screw attachment portion 21 includes a groove 21a that opens to the rear side and to which the screw member SM is fastened. As illustrated in FIG. 4, a predetermined gap is provided between each screw attachment portion 21 on a long side and a corresponding stand-up portion 19a. As illustrated in FIG. 4, one of the heat dissipation members 19 overlaps the flexible boards 26 in a plan view. A space is provided between the heat dissipation member 19 and the screw attachment portion 21 to which the heat dissipation member 19 is attached. Printed circuit boards 27 are arranged in the space. Each of the printed circuit boards 27 includes the flexible boards 26 that are arranged at intervals in a long-side direction of the printed circuit board 27. The flexible boards 26 are connected to the printed circuit board 27 at the other end thereof. The printed circuit board 27 includes a connector (not illustrated) to which an end of an FPC (not illustrated) is connected. The other end of the FPC extends to the rear side of the chassis 14 through an FPC hole (not illustrated) in the chassis 14 and is connected to the control board CTB.

As illustrated in FIG. 3, the chassis 14 has a substantially longitudinal shallow tray shape as a whole and covers overall areas of the light guide plate 16 and the LED unit LU from the rear side. A rear outer surface of the chassis 14 (a surface of the chassis 14 opposite from a surface that faces the LED unit LU) is seen from the rear side and constitutes a back surface of the liquid crystal display device 10. The chassis 14 includes a bottom-plate portion 14a and a pair of LED holding portions (an example of the bottom plate) 14b. The bottom-plate portion 14a has a landscape rectangular shape similar to the light guide plate 16. Each of the LED holding portions 14b protrudes from a long-side edge of the bottom-plate portion 14a toward the rear side to form a step. The LED units LU are arranged in the respective LED holding portions 14b.

As illustrated in FIGS. 3 and 4, the bottom-plate portion 14a has a plane plate shape so as to receive a large portion of the light guide plate 16 in its middle portion with respect to the short-side direction from the rear side (except the end portions with respect to the short-side direction). The bottom-plate portion 14a will be referred to as a light guide plate receiving portion. As illustrated in FIG. 3, ends of the long dimension of the bottom-plate portion 14a extend over the ends of the long dimension of the light guide plate 16. The ends of the bottom-plate portion 14a are screw mount portions 14a1 to which the screw members SM are attached from the outside. The screw members SM hold the frame 13 and the chassis 14 in a fixed condition.

As illustrated in FIGS. 3 and 4, the LED holding portions 14b are located so as to sandwich the bottom-plate portion 14a from ends of the short dimension of the bottom-plate portion 14a. Each LED holding portion 14b is recessed from the bottom plate portion 14a toward the rear side to have a space in which the LED unit LU is arranged. The LED holding portion 14b includes a screw mount portion 14b1 and a pair of side-plate portions 14b2. The screw mount portion 14b1 is parallel to the bottom-plate portion 14a and the screw members SM are attached thereto from the outside. The side-plate portions 14b2 project from ends of the screw mount portion 14b1 toward the front side. One of the side-plate portions 14b2 on the inner side continues to the bottom-plate portion 14a. An inner surface of the screw mount portion 14b1 of the LED holding portion 14b is in surface-contact with a bottom-plate portion 19b of the heat dissipation member 19 of the LED unit LU. The other one of the side-plate portions 14b2 of the LED holding portion 14b on the outer side is fitted in a space provided between the long-side screw attachment portion 21 and the sidewall 13b. The side-plate portion 14b2 on the outer side has a positioning function with which the chassis 14 is properly positioned with respect to the frame 13 in the Y-axis direction.

Next, a configuration of each of the LEDs 17, the LED board 18, and the heat dissipation member 19 included in the LED unit LU will be described. Each LED 17, which is included in the LED unit LU, includes an LED chip (not illustrated). The LED chip is arranged on a board that is fixed on a surface of the LED board 18 facing the light guide plate 16 and sealed with resin. The LED chip mounted on the board has one main light emission wavelength. Specifically, the LED chip that emits light in a single color of blue is used. The resin that seals the LED chip contains phosphors dispersed therein. The phosphors emit light in a predetermined color when excited by blue light emitted from the LED chip. Thus, overall color of light emitted from the LED 17 is white. The phosphors may be selected, as appropriate, from yellow phosphors that emit yellow light, green phosphors that emit green light, and red phosphors that emit red light. The phosphors may be used in combination of the above phosphors. The LED 17 includes a main light-emitting surface that is opposite the light entrance surfaces 16b of the light guide plate 16. Namely, the LED 17 is a so-called top-surface-emitting type LED having a light distribution according to the Lambertian distribution.

As illustrated in FIG. 3, each LED board 18 included in the LED unit LU has an elongated plate-like shape and extends in the long-side direction of the light guide plate 16 (the X-axis direction, the long-side direction of the light entrance surface 16b). The LED boards 18 are arranged in a space between the frame 13 and the chassis 14 such that a plate surface of each LED board 18 is parallel to the X-Z plane, that is, parallel to the light entrance surface 16b of the light guide plate 16. Each LED board 18 has a long-side dimension that is about a half of the long-side dimension of the light guide plate 16. The LED board 18 includes amount surface 18a on which the LEDs 17 are surface-mounted. The mount surface 18a is a plate surface that faces inward, namely, a plate surface that faces the light guide plate 16 (the surface opposite the light guide plate 16). The LEDs 17 are arranged in a line (i.e., linearly) at intervals on the mount surface 18a of the LED board 18 along the long-side direction of the LED board 18 (the X-axis direction). In other words, multiple LEDs 17 are arranged apart from each other along long-side ends of the backlight device 12. Distances between the adjacent LEDs 17 in the X-axis direction are substantially equal, that is, the LEDs 17 are arranged at substantially equal intervals. An arrangement direction of the LEDs 17 corresponds to the longitudinal direction of the LED board 18 (the X-axis direction). A Metal-film trace (not illustrated), such as copper-foil trace, is formed on the mount surface 18a of the LED board 18. The metal-film trace extends in the X-axis direction and crosses over a group of the LEDs 17 so as to connect the adjacent LEDs 17 in series. Terminals at ends of the trace are electrically connected to the power source board PWB via wiring members including connecters and electric wires. Thus, driving power is supplied to the LEDs 17. The LED board 18 includes board through holes 18s along the long-side direction of the LED board 18 (the X-axis direction). Each board through hole 18s has a round opening and extends through the LED board 18 in a thickness direction of the LED board 18 (the Y-axis direction). The fixing screws 40, which will be described later, are inserted in the respective board through holes 18s.

The heat dissipation member 19 included in each LED unit LU is made of metal having high thermal conductivity, such as aluminum. As illustrated in FIG. 6, the heat dissipation member 19 includes a stand-up portion 19a and a bottom portion 19b. The LED board 18 is attached to the stand-up portion 19a. The bottom portion 19b is in surface-contact with a plate surface of the chassis 14. The stand-up portion 19a and the bottom portion 19b form an angle therebetween so as to have an L-like shape in a cross-section. The heat dissipation member 19 has a long dimension substantially equal to the long dimension of the LED board 18. As illustrated in FIGS. 3 and 6, the stand-up portion 19a of the heat dissipation member 19 has a plate-like shape parallel to the plate surface of the LED board 18 and the light entrance surface 16b of the light guide plate 16. A long-side direction, a short-side direction, and a thickness direction of the stand-up portion 19a are aligned with the X-axis direction, the Z-axis direction, and the Y-axis direction, respectively. The LED board 18 is mounted on an inner surface of the stand-up portion 19a, which is a plate surface that faces the light guide plate 16. While the stand-up portion 19a has a long dimension that is substantially equal to the long dimension of the LED board 18, a short dimension of the stand-up portion 19a is larger than a short dimension of the LED board 18. Therefore, ends of the stand-up portion 19a with respect to the short dimension protrude over the LED board 18 in the Z-axis direction. An outer plate surface of the stand-up portion 19a, which is a plate surface opposite from the plate surface on which the LED board 18 is attached, faces the screw attachment portion 21 of the frame 13. The stand-up portion 19a is located between the screw attachment portion 21 of the frame 13 and the light guide plate 16. The stand-up portion 19a projects from an inner end of the bottom portion 19b, which is an end of the bottom portion 19b closer to the LEDs 17 (the light guide plate 16), in the Z-axis direction (a direction in which the liquid crystal panel 11, optical member 15, and the light guide plate 16 overlap each other) toward the front side, that is, toward the frame 13. The stand-up portion 19a includes stand-up portion through holes 19s that are arranged so as to correspond to the respective board through holes 18s. Each of the stand-up portion through holes 19s has a round opening and extends through the stand-up portion 19a in the thickness direction of the stand-up portion 19a (the Y-axis direction). Similar to the board through holes 18s, the fixing screws 40, which will be described later, are inserted in the respective stand-up portion through holes 19s.

As illustrated in FIGS. 3 and 6, the bottom portion 19b of the heat dissipation member 19 has a plate-like shape and is parallel to the plate surface of the chassis 14. A long-side direction, a short-side direction, and a thickness direction of the bottom portion 19b are aligned with the X-axis direction, the Y-axis direction, and the Z-axis direction, respectively. The bottom portion 19b extends from a rear-side end of the stand-up portion 19a in the Y-axis direction toward the outer side. In other words, the bottom portion 19b extends from an end of the stand-up portion 19a closer to the chassis 14 in an opposite direction to the light guide plate 16. The bottom portion 19b has a long dimension substantially equal to the long-side dimension of the stand-up portion 19a. An entire rear plate surface of the bottom portion 19b, which is a plate surface of the bottom portion 19b facing the chassis 14, is in surface-contact with the plate surface of the chassis 14. A front plate surface of the bottom portion 19b, which is a plate surface opposite from the surface in contact with the chassis 14, faces the screw attachment portion 21 of the frame 13. Specifically, the front plate surface of the bottom portion 19b is in contact with a projected end surface of the screw attachment portion 21. The bottom portion 19b is sandwiched between the screw attachment portion 21 of the frame 13 and the chassis 14. With this configuration, heat generated from the LEDs 17 as they are turned on is transferred to the chassis 14 and the frame 13 including the screw attachment portion 21 via the LED board 18, the stand-up portion 19a, and the bottom portion 19b. Therefore, heat is effectively released to the outside of the liquid crystal display device 10 and thus the heat is less likely to stay therein. The bottom portion 19b includes through holes. The screw members SM are passed through the respective through holes. The bottom portion 19b is fixed to the screw attachment portion 21 with the screw members SM.

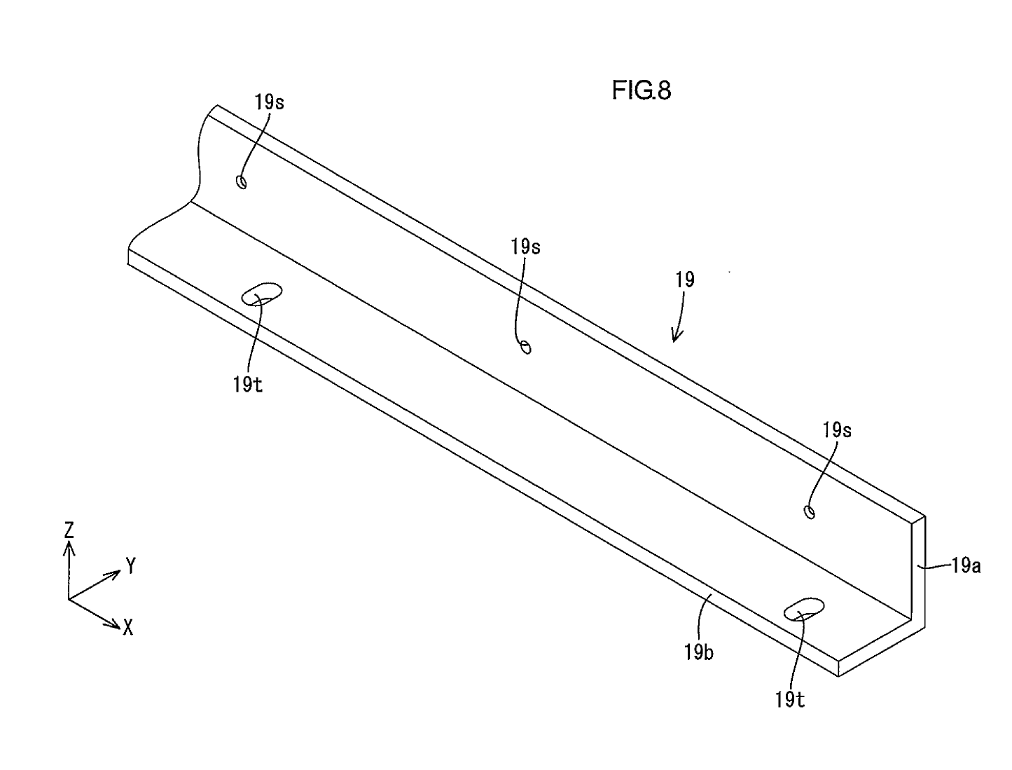

The bottom portion 19b includes bottom-portion through holes 19t that extend in a thickness direction of the bottom portion 19b (the Z-axis direction). The screw members SM are inserted in the respective bottom-portion through holes 19t and fastened to the groove 21a of the screw attachment portion 21. As a result, the bottom portion 19b is held by the frame 13 and the chassis 14. As illustrated in FIGS. 6 and 8, the bottom-portion through hole 19t has an oval shape with a major axis along a direction perpendicular to the light entrance surface 16b of the light guide plate 16 (i.e., the Y-axis direction). With this configuration, the bottom portion 19b (the heat dissipation member 19) which is held between the frame 13 and the chassis 14 with the screw members SM is movable by the length of the major axial of the bottom-portion through hole 19t. In other words, the heat dissipation member 19 is arranged so as to slide in the direction perpendicular to the light entrance surface 16b of the light guide plate 16 relative to the frame 13 and the chassis 14 (i.e., the Y-axis direction).

Next, a configuration and an arrangement of the fixing screws 40 according to this embodiment will be described. Each fixing screw 40 is inserted in the stand-up portion through hole 19s and the board through hole 18s in this sequence from a surface of the stand-up portion 19a opposite from the surface on which the LED board 18 is attached. The tip portion 40b1 of the fixing screw 40 is inserted in the screw hole 16s formed in the light entrance surface 16b of the light guide plate 16. A head portion 40a of the fixing screw 40 is in surface-contact with the surface of the stand-up portion 19a opposite from the surface on which the LED board 18 is attached. The head portion 40a is stopped at the surface so that the fixing screw 40 is less likely to be further inserted toward the light guide plate 16. A shaft portion 40b of the fixing screw 40 is arranged so as to extend through a space between the LED board 18 and the light entrance surface 16b of the light guide plate 16. The shaft portion 40b is arranged along a direction perpendicular to the light entrance surface 16b (the Y-axis direction). Each of the stand-up portion through hole 19s, the board through hole 18s, and the screw hole 16s has an opening. A diameter of each opening is substantially the same as an outer diameter of the fixing screw 40. With this configuration, the fixing screw 40 inserted through the stand-up portion through hole 19s and the board through hole 18s and into the screw hole 16s is tightly fixed and less likely to come off.

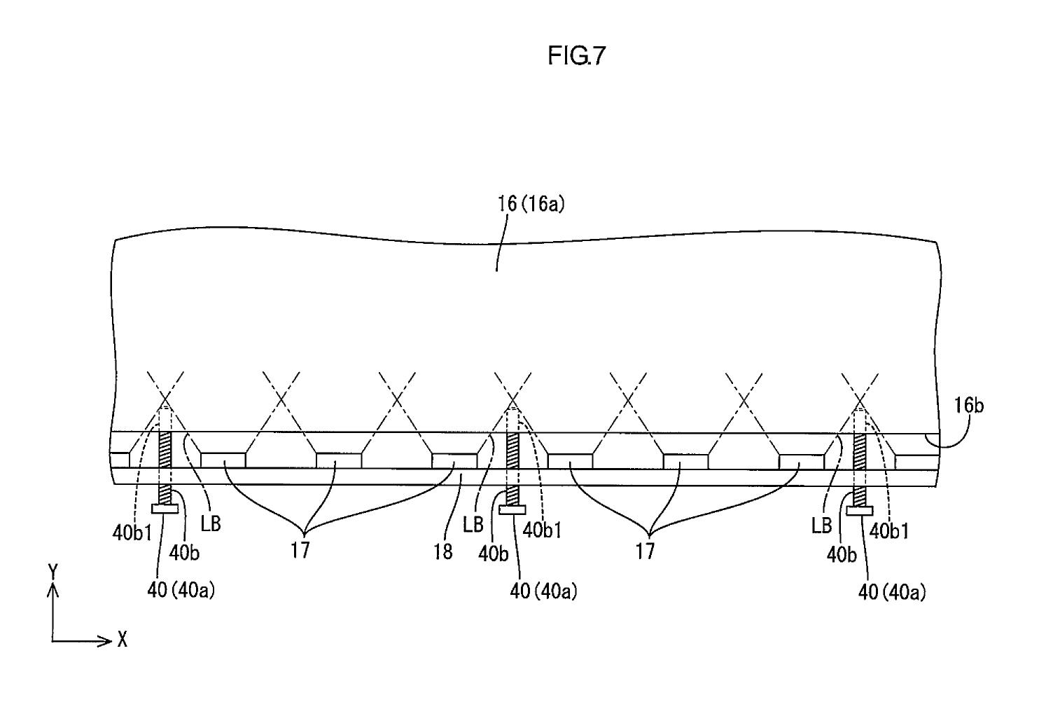

As illustrated in FIGS. 3 and 7, multiple fixing screws 40 are arranged apart from each other along the long-side direction of the LED board 18 (the X-axis direction). Each of the fixing screws 40 arranged along the long-side direction of the LED board 18 (the X-axis direction) is passed through a portion of the LED board 18 between the adjacent LEDs 17. More specifically, each of the board through holes 18s included in the LED board 18 is located at a midpoint between the adjacent LEDs 17. The fixing screws 40 are inserted in the respective board through holes 18s. Namely, each fixing screw 40 is passed through the LED board 18 at the midpoint between the adjacent LEDs 17. Arrangement intervals of the fixing screws 40 may be altered as appropriate according to the intervals between the LEDs 17 or the configuration of the heat dissipation member 19. For example, in an area including the LEDs 17 that are arranged close to each other, an amount of heat generated as light is emitted from the LEDs 17 is large and a variation in size of each component due to the heat is large. In such an area, the fixing screws 40 may be arranged at small intervals so that the LED board 18 is tightly fixed to the light guide plate 16. In another area, the LEDs 17 may be arranged away from each other or a heat generation effect of the heat dissipation member 19 may be high. Therefore, the fixing screws 40 may be arranged at large intervals so that the number of the fixing screws 40 can be reduced.

As illustrated in FIG. 7, each LED 17 has light distribution LB that follows the Lambertian distribution as described earlier. The shaft portion 40b of the fixing screw 40 is inserted through the light entrance surface 16b of the light guide plate 16 into a depth such that the tip portion 40b1 does not overlap a light distribution LB area of the LED 17. In other words, the tip portion 40b1 of the shaft portion 40b is in a dark spot on the light entrance surface 16b of the light guide plate 16 between the adjacent LEDs 17. Therefore, rays of light that exit the LEDs 17 and enter the light guide plate 16 through the light entrance surface 16b are less likely to be blocked by the fixing screws 40.

Next, mounting of the fixing screws 40 during a production process of the liquid crystal display device 10 will be described. During the production process of the liquid crystal display device 10, components are mounted in sequence from the front surface side (an upper side in FIG. 4) of the liquid crystal display device 10. Specifically, the light guide plate 16 and the LED units LU are arranged inside the frame 13, and the chassis 14 is attached to the frame 13. The bottom portion 19b of each heat dissipation member 19 is screwed to the frame 13 and the chassis 14 from the rear side of the chassis 14 and thus the LED units LU are fixed thereto. In the production process including the above steps, the fixing screws 40 are attached to the light guide plate 16 and the LED units LU before the light guide plate 16 and the LED units LU are arranged in the frame 13. Namely, the LED units LU are fixed to the light guide plate 16 in advance by fixing the LED units LU to the light entrance surfaces 16b of the light guide plate 16 with the fixing screws 40. The light guide plate 16 that is connected to the LED units LU is arranged within the frame 13. Accordingly, the LED units LU and the light guide plate 16 that are fixed to each other with the fixing screws 40 is attached to the frame 13 and the chassis 14.

As described earlier, since the LED unit LU and the light entrance surface 16b of the light guide plate 16 are tightly fixed to each other with the fixing screws 40, the LED board 18 is spaced away from the light entrance surface 16b at a fixed distance. In other words, a distance between the light-emitting-surface of the LED 17 and the light entrance surface 16b of the light guide plate 16 is fixed. Therefore, even if thermal expansion and contraction occurs in each of the light guide plate 16, the LED boards 18, the light guide plate 16, and the heat dissipation members 19, the distance between the light-emitting surface of the LED 17 and the light entrance surface 16b of the light guide plate 16 is maintained constant.

As described earlier, in the liquid crystal display device 10 according to this embodiment, the stand-up portion 19a and the LED board 18 are fixed to the light guide plate 16. Therefore, the distance between the LEDs 17 and the light entrance surface 16b is fixed. Even when components, such as the light guide plate 16 and the heat dissipation members 19, thermally expand, the distance between the LEDs 17 and the light entrance surface 16b is maintained. Therefore, the distance between the LEDs 17 and the light entrance surface 16b before the thermal expansion and the distance therebetween after the thermal expansion remain constant. With this configuration, even if the component such as the heat dissipation member 19 expands, light-entering efficiency of rays of light exiting the LEDs 17 and entering through the light entrance surface 16b does not decrease or is less likely to decrease. Namely, proper optical properties can be maintained.

In this configuration, each module includes the liquid crystal display device 10 according to this embodiment. Therefore, the distance between the LEDs and the light entrance surface of each module is maintained constant. With this configuration, production unevenness in the modules does not occur or is less likely to occur.

In the liquid crystal display device 10 according to this embodiment, the bottom portion 19b of the heat dissipation member 19 includes the bottom-portion through holes 19t in which the respective fixing screws 40 are fitted to fix the bottom portion 19b to the chassis 14. Each of the bottom-portion through holes 19t has the oval shape with the major axis along the direction perpendicular to the light entrance surface 16b of the light guide plate 16 (i.e., the Y-axis direction). Therefore, the bottom portion 19b arranged on the bottom plate (LED holding portion 14b) is slidable in the direction perpendicular to the light entrance surface 16b of the light guide plate 16 (the Y-axis direction). If the component such as the heat dissipation member 19 expands in the direction perpendicular to the light entrance surface 16b (the Y-axis direction), the heat dissipation member 19 slides in the direction perpendicular to the light entrance surface 16b (the Y-axis direction) by a length corresponding to the expanded amount. With this configuration, a stress exerted on the heat dissipation member 19 is released and thus warping due to the stress does not occur or is less likely to occur in each component. Therefore, the distance between the LEDs 17 and the light entrance surface 16b is less likely to change.

In the liquid crystal display device 10 according to this embodiment, the LEDs 17 are arranged along the long-side direction of the LED board 18 (the X-axis direction), and each of the fixing screws 40 is passed through the portion of the LED board 18 between the LEDs 17. In this configuration, the LED board 18 and the heat dissipation member 19 are fixed to the light guide plate 16 with the fixing screws 40. Even if the LED board 18 warps along the long-side direction (the X-axis direction), the distance between the LEDs 17 and the light entrance surface 16b does not change or is less likely to change. Therefore, the distance between the LEDs 17 and the light entrance surface 16b is effectively maintained.

In the liquid crystal display device 10 according to this embodiment, each of the fixing screws 40 is passed through the midpoint between the adjacent LEDs 17. In this configuration, each fixing screw 40 is passed through the portion of the LED board 18 equally apart from the adjacent LEDs 17. Therefore, the LED board 18 is fixed with the fixing screws 40 while a force is evenly applied to each portion thereof between the adjacent LEDs 17 without biasing toward one of the adjacent LEDs 17. Thus, the distance between the LED 17 and the light entrance surface 16b is maintained constant with appropriate accuracy.

In the liquid crystal display device 10 according to this embodiment, each LED 17 has the light distribution LB that follows the Lambertian distribution. The tip portion of the fixing screw 40 is in the light entrance surface 16b so as not to overlap the light distribution LB area in which light exiting the LEDs 17 and entering through the light entrance surface 16b is distributed. In this configuration, light that exits the LEDs 17 and enters through the light entrance surface 16b is not blocked by the fixing screws 40. Therefore, uneven brightness does not occur or is less likely to occur at the light exit surface 16a of the light guide plate 16 due to blocking of light by the fixing screws 40.

### Second Embodiment

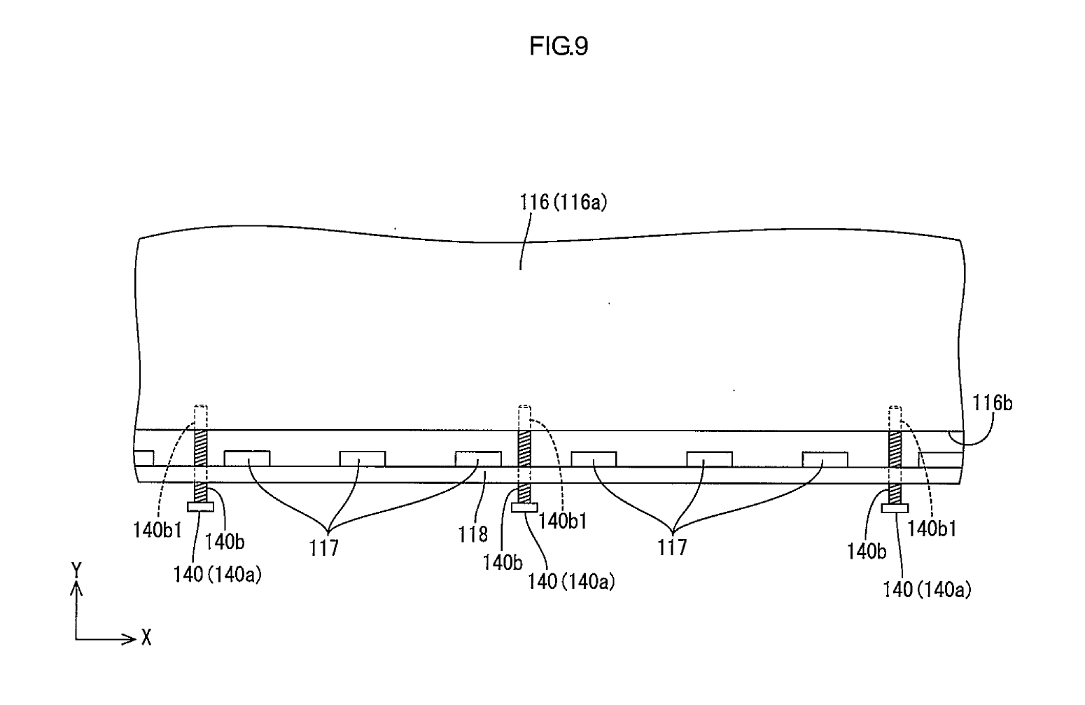

The second embodiment will be described with reference to the drawings. The second embodiment includes fixing screws 140 having different configurations and arrangement from the board attachment member of the first embodiment. The other structures are the same as the first embodiment, and thus configurations, functions, and effects similar to the first embodiment will not be described. In FIG. 9, members and portions indicated by numerals including the reference numerals in FIG. 7 with 100 added thereto have the same configurations as in the first embodiment.

In a liquid crystal display device according to the second embodiment, fixing screws 140 have transparency. Materials having transparency may be selected from polymethyl methacrylate resin, polystyrene resin, and methyl methacrylate-styrene copolymer resin, which are materials used for a light guide plate 116. As illustrated in FIG. 9, the fixing screws 140 are passed through an LED board 118. Each fixing screw 140 is located between a midpoint of adjacent LEDs 117 and one of the adjacent LEDs 117. In the configuration including the transparent fixing screws 140, even if rays of light from the LEDs 117 reach the fixing screws 140 (i.e., even if a tip portion 140b1 of the fixing screw 140 is in the light distribution LB area in which light that exits the LEDs 117 and enters through the light entrance surface 116 is distributed), the rays of light are less likely to be blocked by the fixing screws 140. Therefore, the fixing screws 140 can be arranged close to the LEDs 117 as described above. In comparison to a case in which the fixing screw 140 is passed through the LED board 118 at the midpoint of the adjacent LEDs 117, each fixing screw 140 in this configuration is placed closer to the LED 117. Therefore, the distance between the LEDs 117 and the light entrance surface 116b is fixed at a point close to the LED 117. Namely, the distance between the LEDs 117 and the light entrance surface 116b is fixed with appropriate accuracy.

### Third Embodiment

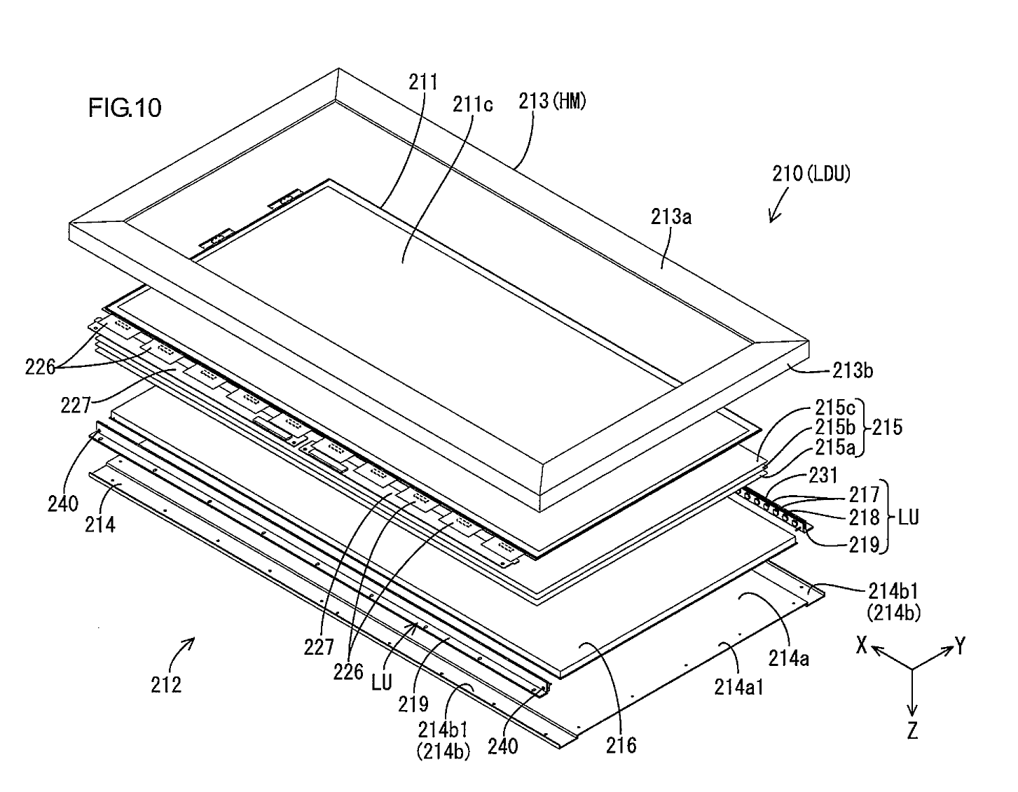

The third embodiment will be described with reference to the drawings. The third embodiment includes fixing screws 240. The number and arrangement of fixing screws 240 differs from those in the first embodiment. The other structures are the same as the first embodiment, and thus configurations, functions, and effects similar to the first embodiment will not be described. In FIG. 10, members and portions indicated by numerals including the reference numerals in FIG. 3 with 200 added thereto have the same configurations as in the first embodiment.

As illustrated in FIG. 10, in a liquid crystal display device 210 according to the third embodiment, two fixing screws 240, 240 are passed through end portions of a long dimension of an LED board 218 (i.e., end portions in the X-axis direction), respectively. With this configuration in which the fixing screws 240 are arranged only in the end portions of the LED board 218, the number of fixing screws 240 can be reduced and thus the production process can be simplified and the component cost is reduced. Further, each fixing screw 240 is passed through a portion of the LED board 218 between a middle of a short dimension of the LED board 218 (i.e., in the Z-axis direction) and an end of the LED board 218 close to a chassis 214 (i.e., a rear side). Accordingly, a tip portion of the fixing screw 240 is passed through a light entrance surface 216b so as to correspond to the portion between the middle of the short dimension of the LED board 218 (the Z-axis direction) and the end of the LED board 218 close to the chassis 214 (the rear side). Furthermore, similar to the first embodiment, LEDs 217 mounted on the LED board 218 are located substantially the middle of the short dimension of the LED board 218 (the Z-axis direction). In such an arrangement of the fixing screws 240 and the LEDs 217, the tip portions 240b1 of the fixing screws 240 that are inserted in the light entrance surface 216b are located outside the light distribution LB area, in which light exiting the LEDs 117 and entering through the light entrance surface 116 is distributed. Namely, light emitted from the LEDs 217 is less likely to be blocked by the fixing screws 240. Therefore, uneven brightness does not occur or is less likely to occur at the light exit surface 216a of a light guide plate 216 due to blocking of light by the fixing screws 240.

Modifications of the above embodiments will be listed below.

(1) In the above embodiments, the configuration in which the fixing screws are arranged at intervals along the longitudinal direction of the LED board 18 and the configuration in which the fixing screw is arranged at each end of the long dimension of the LED board are described. However, the number and arrangement of the fixing screws are not limited to the above embodiments. For example, the fixing screws may be arranged between the adjacent LEDs along the short-side direction of the LED board.

(2) In each of the above embodiments, the bottom portion of the heat dissipation member is arranged on the LED holding portion of the chassis so as to be slidable in the direction perpendicular to the light entrance surface. However, the bottom portion of the heat dissipation member may be fixed to the chassis. Even in such a case, the distance between the LEDs and the light entrance surface is maintained with the fixing screws. Therefore, even when the component such as the light guide plate thermally expands or contracts, the distance between the LEDs and the light entrance surface is less likely to change.

(3) In each of the above embodiments, the light distribution of each LED follows the Lambertian distribution. However, the LED may have light distribution not following the Lambertian distribution.

(4) In each of the above embodiments, the LED units LU are arranged so as to sandwich the light guide plate from the long sides of the light guide plate. However, the LED unit may be arranged on one side of the light guide plate. Furthermore, the LED units may be arranged on three or all sides of the light guide plate. In such cases, each LED unit may fix to the light guide plate with fixing screws.

(5) The configuration, arrangement, number, and shape of the fixing screws can be altered from those in the above embodiments as appropriate.

(6) In each of the above embodiments, the liquid crystal display device does not include a cabinet. However, the aspect of this invention can be applied to a liquid crystal display device including a cabinet.

(7) In each of the above embodiments, the liquid crystal display device including the liquid crystal panel as the display panel is used. However, the aspect of this invention can be applied to display devices including other types of display panels.

The embodiments have been described in detail. However, the above embodiments are only some examples and do not limit the scope of the claimed invention. The technical scope of the claimed invention includes various modifications of the above embodiments.

The technical elements described in this specification and the drawings may be used independently or in combination to achieve the technical benefits. The combinations are not limited to those in claims. With the technologies described in this specification and the drawings, multiple objectives may be accomplished at the same time. However, the technical benefits can be achieved by accomplishing even only one of the objectives.

### EXPLANATION OF SYMBOLS

TV: television device, LDU, liquid crystal display unit, PWB: power board, MB: main board, CTB: control board, CV: cover, ST: stand, LU: LED unit, 10, 210: liquid crystal display device, 11, 211: liquid crystal panel, 12, 212: backlight device, 13, 213: frame, 14, 214: chassis, 15, 215: optical member, 16, 116, 216: light guide plate, 16b, 116b, 216b: light entrance surface, 17, 117, 217: LED, 18, 118, 218: LED board, 19, 119, 219: heat dissipation member, 19a, 119a, 219a: stand-up portion, 19b, 119b, 219b: bottom portion, 16s: screw hole, 20: reflection sheet, 40, 140, 240: fixing screw.

1. A display device comprising:
a light source;
a display panel configured to provide a display using light from the light source;
a light guide plate arranged on an opposite side from a display surface side of the display panel so as to overlap the display panel and configured to guide light from the light source toward the display panel, the light guide plate including at least a side surface configured as a light entrance surface, the light entrance surface facing the light source;
a chassis including at least a bottom plate and arranged on an opposite side of the light guide plate from the display panel;
a frame arranged on the display surface side of the display panel and holding the display panel, the light source, and the light guide plate between the frame and the chassis;
a light source board having a surface on which the light source is mounted and arranged such that the surface thereof is parallel to the light entrance surface;
a heat dissipation member having a heat dissipation property and including a bottom portion and a stand-up portion, the bottom portion being arranged on the bottom plate along the bottom plate, the stand-up portion projecting from the bottom portion toward a display panel side and including a surface on which the light source board is mounted; and
a fixing screw passed through the stand-up portion and the light source board and including a tip portion fixed in the light entrance surface, the fixing screw fixing the stand-up portion and the light source board to the light guide plate.

2. The display device according to claim 1, wherein the bottom portion is arranged on the bottom plate so as to be slidable in a direction perpendicular to the light entrance surface.

3. The display device according to claim 2, wherein the bottom portion includes a bottom-portion through hole through which an attachment member for attaching the bottom portion to the chassis is to be passed, the bottom-portion through hole having an oval shape with a major axis along the direction perpendicular to the light entrance surface.

4. The display device according to claim 1, wherein
the light source board has a rectangular shape,
the light source includes a plurality of light sources arranged along a longitudinal direction of the light source board, and
the fixing screw includes a plurality of fixing screws, each of the fixing screws being passed through a portion of the light source board between the light sources.

5. The display device according to claim 4, wherein each of the fixing screws is passed through the light source board at a midpoint between the adjacent light sources.

6. The display device according to claim 4, wherein
the light source has a light distribution following the Lambertian distribution, and
the tip portion of the fixing screw is in the light entrance surface so as not to overlap a light distribution area in which light exiting the light source and entering through the light entrance surface is distributed.

7. The display device according to claim 4, wherein each of the fixing screws is made of material having a transparency and passed through the light source board at a point between a midpoint of the adjacent light sources and one of the adjacent light sources.

8. The display device according to claim 1, wherein
the light source board has a rectangular shape, and
the fixing screw includes at least two fixing screws, each of the fixing screws being passed through an end portion of a long dimension of the light source board.

9. The display device according to claim 8, wherein
the light source is arranged in a substantially middle portion of a short dimension of the light source board, and
the fixing screw is passed through the light source board at a point between the middle portion of the short dimension of the light source board and a side of the light source board close to the bottom plate.

10. The display device according to claim 1, wherein the display panel is a liquid crystal display panel including liquid crystals.

11. A television device comprising the display device according to claim 1.
